(19) United States
(12) Patent Application Publication
(10) Pub. No.: US 2012/0069078 A1
(43) Pub. Date: Mar. 22, 2012

(54) INKJET RECORDING APPARATUS AND INKJET RECORDING METHOD

(75) Inventors: Yoshiaki Kaneko, Shizuoka-ken (JP); Hirofumi Kondo, Kanagawa-ken (JP); Takao Izumi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/232,528

(22) Filed: Sep. 14, 2011

Related U.S. Application Data
(60) Provisional application No. 61/384,068, filed on Sep. 17, 2010.

(51) Int. Cl. B41J 29/38

(52) U.S. Cl. 347/16

(57) ABSTRACT

According to one embodiment, an inkjet recording apparatus includes a retaining roller, a charging member, an inkjet head, a reversing device, and a controller. The retaining roller retains a recording medium on the surface thereof and rotates. The charging member is arranged to be opposed to the surface of the retaining roller and attracts the recording medium to the surface of the retaining roller with electrostatic force and retains the recording medium on the surface of the retaining roller. The controller controls a position in an approaching and separating direction of the charging member with respect to the retaining roller if the recording medium is reversed by the reversing device after image formation on a first surface of the recording medium and then electrostatically attracted with a second surface of the recording medium faced to the outer side.

### CROSS-REFERENCE TO RELATED APPLICATIONS

This application claims the benefit of U.S. Provisional Application No. 61/384,068 filed on Sep. 17, 2010.

### FIELD

Embodiments described herein relate generally to an inkjet recording apparatus and an inkjet recording method.

### BACKGROUND

As the inkjet recording apparatus, there is an inkjet recording apparatus that rotates a retaining roller with a recording medium such as a sheet retained on the surface thereof to thereby convey the recording medium along the outer circumference of the retaining roller and performs image formation on the recording medium in an image forming section provided in the outer circumferential section of the retaining roller. In this inkjet recording apparatus, for example, the recording medium is pressed against and closely attached to the surface of the retaining roller by a retaining device including a pressing mechanism and an attraction mechanism and is attracted to the surface of the retaining roller with electrostatic force, whereby the recording medium is retained on the surface of the retaining roller.

As such an inkjet recording apparatus, there is an inkjet recording apparatus for duplex printing that includes a reversing device configured to reverse a recording medium, reverses the front and rear surfaces of the recording medium after forming an image on one principal plane of the recording medium, retains the recording medium on the surface of a retaining roller again, and forms an image on the other principal plane of the recording medium. In the inkjet recording apparatus for duplex printing, if a recording medium once absorbs moisture through printing, charges easily escape from the recording medium because of the moisture. Therefore, it is difficult to attract the recording medium to the retaining roller again with electrostatic force.

### BRIEF DESCRIPTION OF THE DRAWINGS

FIG. 1 is an explanatory diagram of the configuration of an inkjet recording apparatus according to a first embodiment;

FIG. 2 is an explanatory diagram of the vicinity of a retaining device of the inkjet recording apparatus according to the first embodiment;

FIG. 3 is a graph of a relation between a nip passing time and a potential difference according to the first embodiment;

FIG. 4 is a block diagram of a system configuration of the inkjet recording apparatus according to the first embodiment;

FIG. 5 is a flowchart for explaining actions of the inkjet recording apparatus according to the first embodiment;

FIG. 6 is an explanatory diagram of the configuration of an inkjet recording apparatus according to a second embodiment;

FIG. 7 is an explanatory diagram of the vicinity of a retaining device of the inkjet recording apparatus according to the second embodiment;

FIG. 8 is a block diagram of a system configuration of the inkjet recording apparatus according to the second embodiment; and

FIG. 9 is a flowchart for explaining actions of the inkjet recording apparatus according to the second embodiment.

### DETAILED DESCRIPTION

In general, according to one embodiment, an inkjet recording apparatus includes a retaining roller, a charging member, an inkjet head, a reversing device, and a controller. The retaining roller retains a recording medium on the surface thereof and rotates. The charging member is arranged to be opposed to the surface of the retaining roller and attracts the recording medium to the surface of the retaining roller with electrostatic force and retains the recording medium on the surface of the retaining roller. The inkjet head is provided to be opposed to the outer circumferential surface of the retaining roller and ejects ink to the recording medium retained on the surface of the retaining roller to form an image on the recording medium. The reversing device reverses the front and rear surfaces of the recording medium. The controller controls a position in an approaching and separating direction of the charging member with respect to the retaining roller if the recording medium is reversed by the reversing device after image formation on a first surface of the recording medium and then electrostatically attracted with a second surface of the recording medium faced to the outer side.

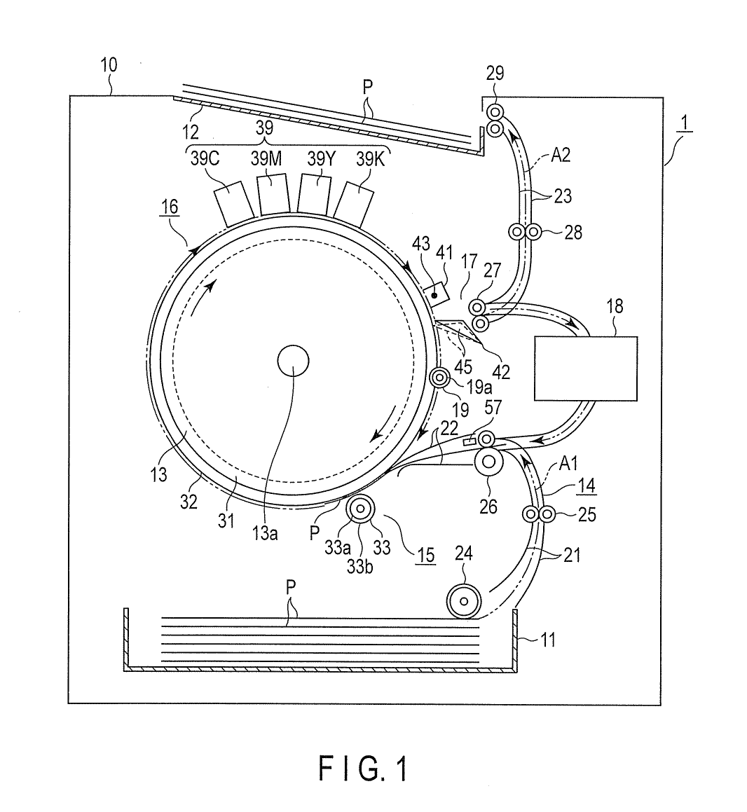

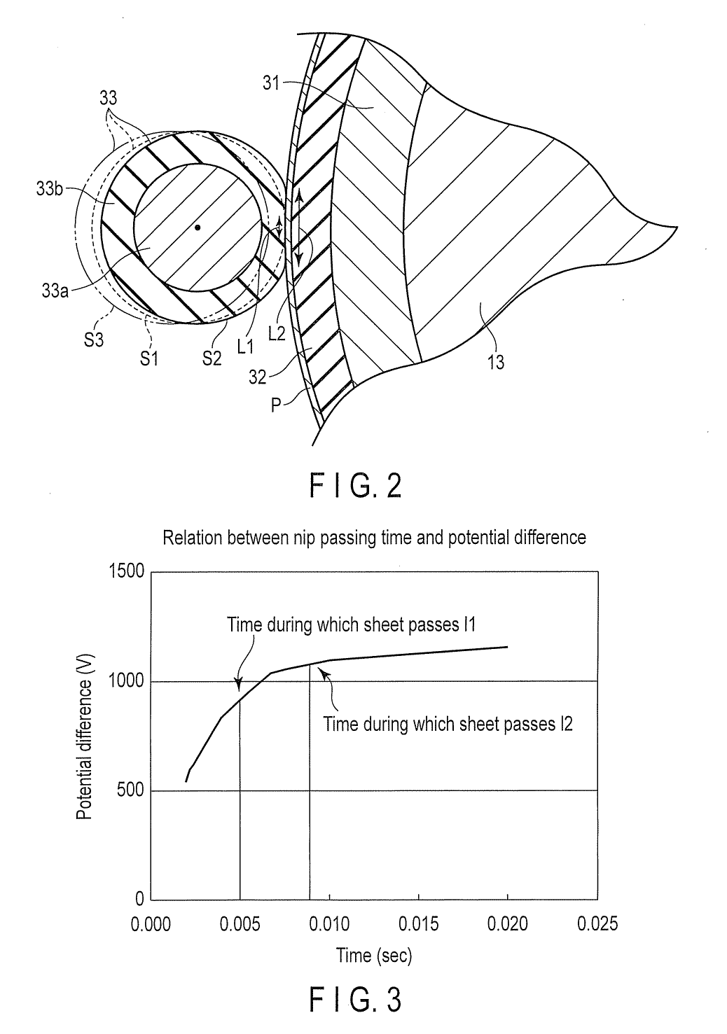

An inkjet recording apparatus 1 according to a first embodiment is explained below. In the figures, components are expanded, reduced, or omitted as appropriate to schematically show the components. FIG. 1 is an explanatory diagram of a mechanism of the inkjet recording apparatus 1 according to this embodiment. FIG. 2 is a block diagram of a system of the inkjet recording apparatus 1.

The inkjet recording apparatus 1 shown in FIG. 1 is, for example, an apparatus that performs various kinds of processing such as image formation while conveying a sheet P, which is a recording medium. The inkjet recording apparatus 1 includes a housing 10 that forms an outer hull, a paper feeding cassette 11 functioning as a sheet feeding section provided on the inside of the housing 10, a paper discharge tray 12 functioning as a discharge section provided in an upper part of the housing 10, an image forming section 16 including a retaining roller (a drum) 13 configured to retain the sheet P on the outer surface thereof and rotate, a reversing device 18 configured to reverse the front and rear surfaces of the sheet P peeled off the drum 13 and feed the sheet P onto the surface of the drum 13 again, and a conveying device 14 configured to convey the sheet P along conveying paths A1 and A2 from the paper feeding cassette 11 to the drum 13 and from the drum 13 to the discharge section.

The conveying device 14 includes plural guide members 21 to 23 provided along the conveying path A1 and plural conveying rollers 24 to 29 provided along the conveying path A2. As the conveying rollers, a pickup roller 24, a paper feeding roller pair 25, a resist roller pair 26, a separating roller pair 27, a conveying roller pair 28, and a discharge roller pair 29 are provided. A sheet position sensor 57 configured to detect the leading end position of the sheet P is provided near a nip of the resist roller pair 26 in the conveying path A1.

The image forming section 16 includes, besides the drum 13, in order from an upstream side to a downstream side starting from a position where a guide member 22 and the drum 13 are in close contact with each other in the outer circumferential section of the drum 13, a retaining device 15 configured to press the sheet P against the outer surface of the drum 13 and attract the sheet P to the surface (the outer circumferential surface) of the drum 13 to retain the sheet P, an inkjet head unit 39 configured to form an image on the sheet P retained on the outer surface of the drum 13, an electricity removing and peeling device 17 configured to remove electricity of the sheet P and peel the sheet P off the drum 13, and a cleaning device 19 configured to clean the drum 13.

The drum 13 includes a rotating shaft 13a, a cylindrical frame 31 functioning as a conductive section formed of aluminum, which is a conductor, in a cylindrical shape, and a thin insulating layer 32 formed on the surface of the cylindrical frame 31. The drum 13 is formed in a cylindrical shape having a fixed length in an axis direction.

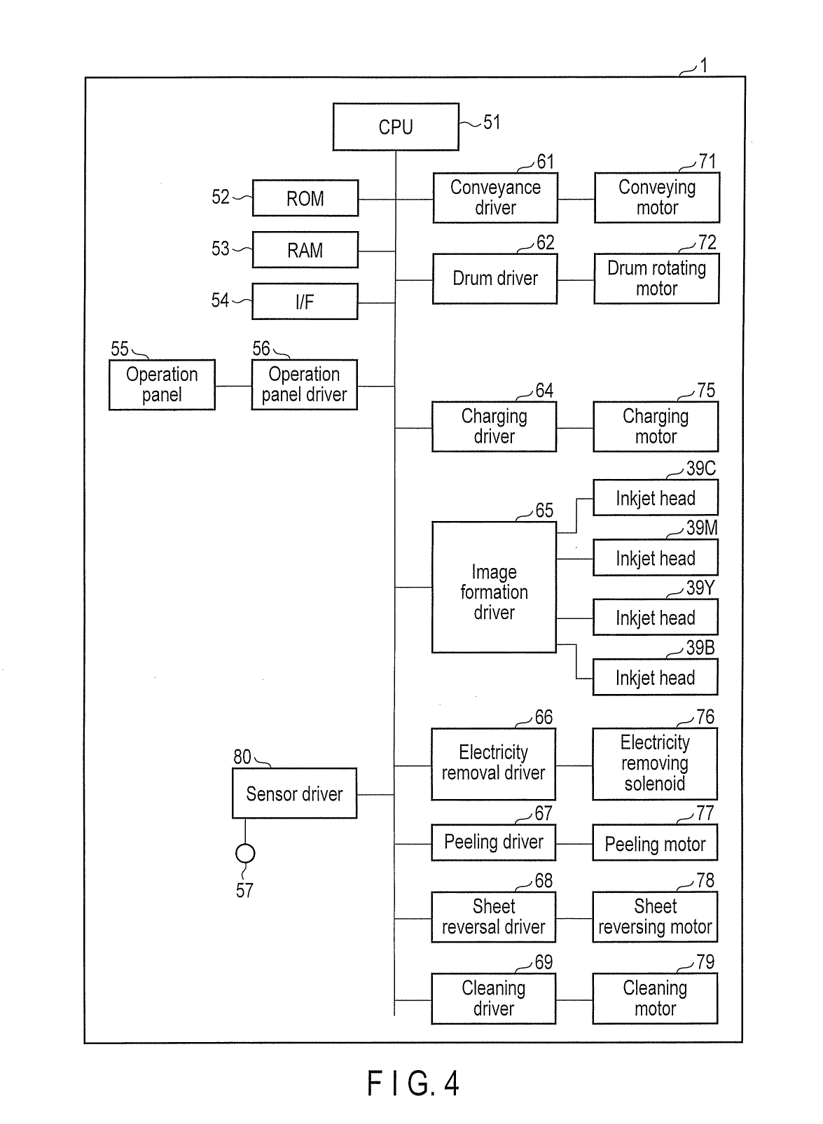

The retaining device 15 is a contact-type charging device including a charging roller (a charging member) 33 configured to be chargeable and configured to be capable of pressing the sheet P against the drum 13 and a charging motor 75 shown in FIG. 4 for moving the charging roller 33 to the drum 13.

If charges are supplied to the charging roller 33, a potential difference between the charging roller 33 and the grounded cylindrical frame 31 occurs. The charging roller 33 generates electrostatic force in a direction in which the sheet P is attracted to the drum 13 (charges the sheet P). It is possible to switch a supply state of charges to the charging roller 33.

The charging roller 33 includes a charging shaft 33a functioning as a chargeable conductive section of metal extending in parallel to the rotating shaft 13a and a surface layer section 33b formed on the outer circumference of the charging shaft 33a. The surface layer section 33b of the charging roller 33 is made of an insulating material and prevents charges of the charged sheet P from leaking through the charging roller 33. The surface layer section 33b is formed of an elastically deformable material such as a rubber material.

As shown in FIG. 2, the axis position of the charging shaft 33a of the charging roller 33 can be moved in plural stages in a direction in which the charging roller 33 approaches and separates from the surface of the drum 13. The axis position of the charging roller 33 can be switched among a first state S1 in which the charging roller 33 presses the surface of the drum 13 with first pressing force, a second state S2 in which the charging roller 33 presses the surface of the drum 13 with second pressing force larger than the first pressing force, and a third state S3 in which the charging roller 33 retracts from the drum 13 and the pressing is released. A load applied between the charging roller 33 and the drum 13 is set to a proper value with which the sheet P is not deformed and image quality is not deteriorated.

The surface layer section 33b of the charging roller 33 is elastically deformable according to pressing force. If the surface layer section 33b of the charging roller 33 is pressed against the drum 13, the length L of a nip between the surface layer section 33b and the drum 13 changes while the surface layer section 33b is deformed according to a load. A second nip length L2 in the second state S2 is larger than a first nip length L1 in the first state S1.

The sheet P passes through a nip between the retaining roller 13 and the charging roller 33 according to the rotation of the drum 13. Therefore, if a certain point on the sheet P is set as a reference, a second nip passing time in which the sheet P passes the second nip length L2 is longer than a first nip passing time in which the sheet P passes the first nip length L1.

FIG. 3 is a graph of a relation between a nip passing time and a (surface) potential difference. As shown in FIG. 3, the (surface) potential difference increases as the nip passing time increases. Therefore, if the nip passing time is long, generated electrostatic force increases.

In this embodiment, the potential difference indicates a difference in potential between the cylindrical frame 31 of the set drum 13 and the surface of paper. As shown in FIG. 3, a second nip passing time is longer than a first nip passing time. The second nip passing time is time not exceeding a period twice as long as the second nip passing time.

Specifically, the first nip passing time is 0.005 second and the second nip passing time is 0.009 second.

In this embodiment, pressing force (load), a nip length, a nip passing time (a charging time), and a (surface) potential difference are adjusted to adjust electrostatic attraction force by changing the position of the charging roller 33.

Charge attraction and pressing can be simultaneously performed by nipping the sheet P and pressing the sheet P against the drum 13 from the outer side in a state in which the charging roller 33 is charged as shown in FIG. 2. When the sheet P passes the nip between the drum 13 and the charging roller 33, electrostatic force is generated by a potential difference between the charging roller 33 and the drum 13 to electrostatically attract the sheet P to the drum 13 and the sheet P is pressed against the drum 13 by the charging roller 33, whereby the sheet P adheres to the surface of the drum 13 while creases of the sheet P are smoothed.

Referring back to FIG. 1, the inkjet head unit 39 including plural inkjet heads is arranged in an upper part of the surface of the drum 13 and on the opposite side of the charging roller 33 across the drum 13. The inkjet head unit 39 is arranged to be opposed to the drum 13. The inkjet head unit 39 is arranged further on the downstream side than the charging roller 33 with respect to a position where the guide member 22 and the drum 13 are in close contact with each other.

The inkjet head unit 39 includes inkjet heads 39c, 39m, 39y, and 39b. The inkjet heads 39c, 39m, 39y, and 39b for four colors of cyan, magenta, yellow, and black are respectively provided. The inkjet heads 39c, 39m, 39y, and 39b for the four colors eject inks to the sheet P from nozzles provided at a predetermined pitch to form an image. As the inks of the respective colors, for example, aqueous inks are used.

The electricity removing and peeling device 17 includes an electricity removing device 41 configured to remove electricity of the sheet P and a peeling device 42 configured to peel the sheet P off the surface of the drum 13 after the electricity removal.

The electricity removing device 41 is provided further on the downstream side than the inkjet head unit 39 with respect to the position where the guide member 22 and the drum 13 are in close contact with each other. The electricity removing device 41 includes a chargeable electricity removing roller 43. The electricity removing device 41 supplies charges to the sheet P to remove electricity of the sheet P to release attraction force and make it easy to peel the sheet P off the drum 13.

The peeling device 42 is provided further on the downstream side than the electricity removing device 41 with respect to the position where the guide member 22 and the drum 13 are in close contact with each other. The peeling device 42 includes a′pivotable (movable) separation claw 45. The separation claw 45 can pivot between a peeling position where the separation claw 45 is inserted between the sheet P and the drum 13 and a retraction position where the separation claw 45 retracts from the drum 13. In a state in which the separation claw 45 is arranged in the peeling position, the separation claw 45 peels the sheet P off the surface of the drum 13. In FIG. 1, the state in which the separation claw 45 is present in the peeling position is indicated by a broken line and a state in which the separation claw 45 is present in the retracted position is indicated by a solid line.

The cleaning device 19 is provided further on the downstream side than the peeling device 17 with respect to the position where the guide member 22 and the drum 13 are in close contact with each other.

The reversing device 18 is provided between the conveying path A1 and the conveying path A2. The reversing device 18 reverses the sheet P peeled by the peeling device 42 and feeds the sheet P onto the surface of the drum 13 again. As the reversing device 18, any publicly-known mechanism such as a mechanism for switching back the sheet P to be reversed in a front-back direction may be used.

As shown in FIG. 4, the inkjet recording apparatus 1 includes a CPU (central processing unit) 51, which is a controller, a ROM (read only memory) 52 having stored therein various computer programs and the like, a RAM (random access memory) 53 configured to temporarily store various variable data, image data, and the like, and an interface (I/F) 54 configured to receive input of data from the outside and output data to the outside.

The inkjet recording apparatus 1 includes a conveying motor control driving circuit (driver) 61 configured to control a conveying roller motor 71 coupled to the rollers 24 to 29 functioning as conveying rollers, a drum control driving circuit (driver) 62 configured to control a drum rotating motor 72 coupled to the drum 13, a charging control driving circuit (driver) 64 configured to control the charging motor 75 connected to the charging roller 33 to supply charges to the charging roller 33 and bring the charging roller 33 into contact with and separate the charging roller 33 from the drum 13, an image formation control driving circuit (driver) 65 configured to control the inkjet heads 39c, 39m, 39y, and 39b, an electricity removal control driving circuit (driver) 66 configured to control an electricity removing solenoid 76 connected to the separation claw 45, a peeling control driving circuit (driver) 67 configured to control a peeling motor 77 coupled to the separation claw 45, a sheet reversal control driving circuit (driver) 68 configured to control a sheet reversing motor 78 coupled to the reversing device 18, a cleaning control driving circuit (driver) 69 configured to control a cleaning motor 79 coupled to a cleaning member 19a, a sensor control driving circuit (driver) 80 configured to control the sensor 57, and an operation panel control driving circuit (driver) 55 configured to control an operation panel 56.

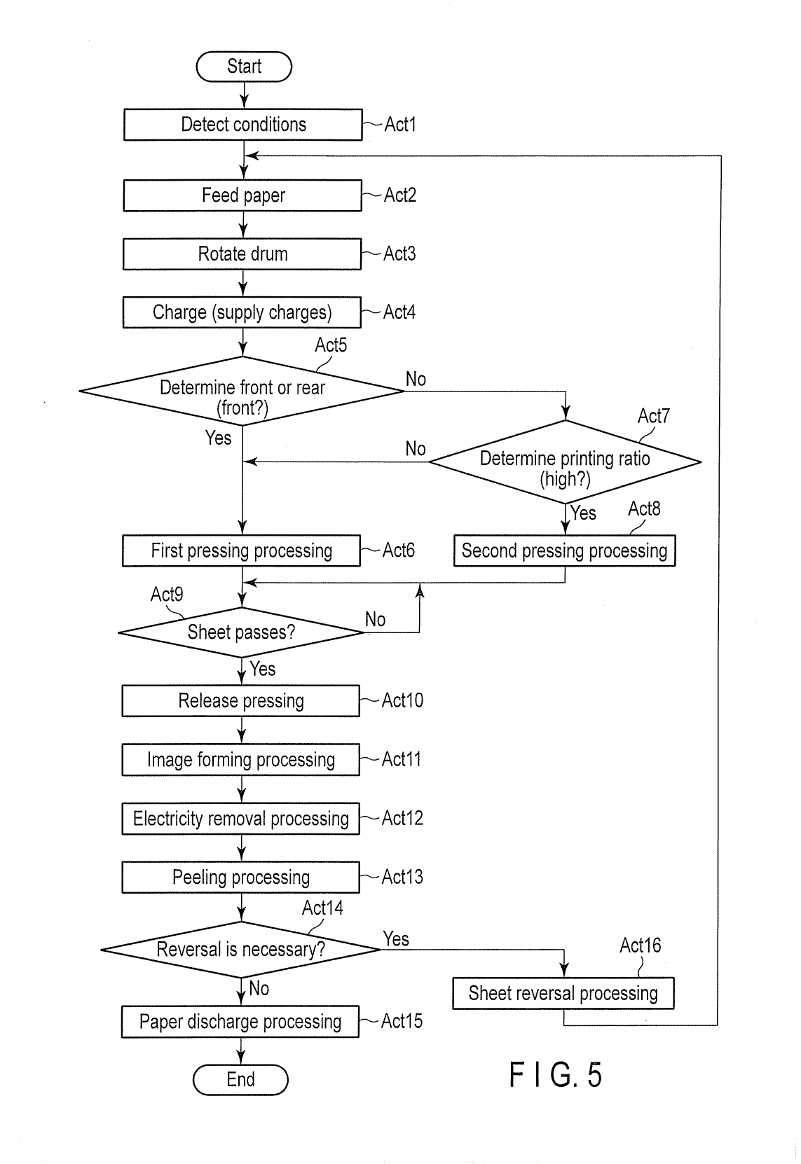

Actions of the inkjet recording apparatus 1 according to this embodiment are explained below with reference to a flowchart of FIG. 5.

First, the CPU 51 detects various conditions (Act 1). The conditions are, for example, a printing ratio besides necessity of duplex printing. The CPU 51 detects these conditions from information detected by the sensor 57 or information input from the interface 54.

The CPU 51 detects conditions such as a printing mode of duplex printing or simplex printing, the resolution of image formation, and a color mode via the interface 54 on the basis of, for example, a setting input by a user.

The CPU 51 determines conditions such as a printing ratio, a color, and printing speed on the basis of information concerning an image to be printed and information such as resolution. Besides, the CPU 51 detects conditions such as the position of the sheet P with the sensor 57.

Subsequently, the CPU 51 performs paper feeding processing (Act 2). At this point, the position of the charging roller 33 is in the third state 53.

At predetermined timing when the sheet P is supplied onto the surface of the drum 13, the CPU 51 instructs the drum control driving circuit (driver) 62 to rotate the drum 13 (Act 3).

The CPU 51 instructs the charging control driving circuit 64 to generate electrostatic force in the nip between the charging roller 33 and the drum 13 and attract the sheet P (Act 4). Timing for charging is set such that, for example, the charging roller 33 is charged immediately before the sheet P reaches the charging roller 33 according to the rotation of the drum 13.

The CPU 51 determines, on the basis of the condition of necessity of duplex printing detected in Act 1, whether present image formation is performed on the front surface (a first surface) (Act 15). If the CPU 51 determines that the present image formation is performed on the front surface (YES in Act 5), the CPU 51 instructs the charging control driving circuit (driver) 64 to perform first pressing processing with a potential difference between the charging roller 33 and the drum 13 set as a first potential difference (Act 6).

Specifically, in the case of a state in which the front surface of the sheet P before reversal is faced outward, the CPU 51 instructs the charging control driving circuit (driver) 64 to perform the first pressing processing such that the position of a pressing roller 35 is in the first state S1. A nip length at this point is the first nip length L1. In Act 6, charges are supplied from the charging control driving circuit (driver) 64 to the charging roller 33.

The sheet P fed by the resist roller pair 26 winds around and is attracted to the drum 13 by electrostatic force to be closely attached to the drum 13 while unevenness such as creases is smoothed by the charging roller 33. The sheet P passes through the nip between the pressing roller 35 and the drum 13 in the first nip passing time. The attracted and retained sheet P is directly conveyed to the inkjet head unit 39 according to the rotation of the drum 13.

On the other hand, if the CPU 51 determines that the present image formation is not performed on the front surface, i.e., determines that the present image formation is performed on the rear surface (the second surface) (NO in Act 5), the CPU 51 determines whether a printing ratio is higher than a threshold set in advance (Act 7). If the CPU 51 determines that the printing ratio is higher than the threshold (YES in Act 7), the CPU 51 instructs the charging control driving circuit (driver) 64 to perform second pressing processing with the potential difference between the charging roller 33 and the drum 13 set as a second potential difference (Act 8). Specifically, the CPU 51 instructs the charging control driving circuit (driver) 64 to perform the second pressing processing such that the position of the pressing roller 35 is in the second state S2. A nip length at this point is the second nip length L2. As potential charged in the charging roller 33 at this point, the same potential is supplied in the first state S1 and the second state S2.

On the other hand, if the CPU 51 determines that the printing ratio is lower than or equal to the threshold (NO in Act 7), the CPU 51 proceeds to Act 6.

For example, in the case of a state in which the rear surface of the sheet P after reversal is faced outward, the CPU 51 performs control to set the position of the pressing roller 35 in the second state S2 and performs, as the second pressing processing, pressing processing with a second pressing load larger than a first pressing load. A nip length at this point is the second nip length L2 larger than the first nip length L1.

The sheet P fed by the resist roller pair 26 first winds around and is attracted to the drum 13 by electrostatic force to be closely attached to the drum 13 while unevenness such as creases is smoothed by the charging roller 33. The sheet P passes through the nip between the pressing roller 35 and the drum 13 in the second nip passing time longer than the first nip passing time. Therefore, in the second pressing processing, the sheet P is attracted and retained with a potential difference larger than that in the first pressing processing. The attracted and retained sheet P is directly conveyed to the inkjet head unit 39 according to the rotation of the drum 13.

The CPU 51 determines whether the trailing end of the sheet P passes the nip and moves further to the downstream side than the charging roller 33 with respect to the position where the guide member 22 and the drum 13 are in close contact with each other (Act 9). If the CPU 51 determines that the trailing end of the sheet P passes the nip (YES in Act 9), the CPU 51 instructs a pressing motor control driving circuit 63 to retract the pressing roller 35 (Act 10). In other words, the CPU 51 performs control such that the pressing roller 35 is in the third state S3.

Subsequently, the CPU 51 performs image forming processing (Act 11). In the image forming processing, the CPU 51 instructs the image formation control driving circuit 65 to cause the inkjet heads 39c, 39m, 39y, and 39b to eject the inks to the front surface of the sheet P and perform printing. At this point, image formation is performed according to various conditions such as resolution and a printing mode. When the drum 13 is rotated plural times while the sheet P is kept attracted thereto, the separation claw 45 of the peeling device 17 and the cleaning member 19a of the cleaning device 19 are set in retracted positions to allow conveyance of the sheet P.

After the end of the image forming processing, the CPU 51 drives the electricity removing device 41 (Act 12) to thereby remove electricity of the sheet P and releases electrostatic attraction force. Further, the CPU 51 drives the peeling device 42 on the downstream side (Act 13) to thereby peel the sheet P off the surface of the drum 13.

The CPU 51 determines whether a reversal of the sheet P is necessary (Act 14). If the CPU 51 determines that the reversal of the sheet P is unnecessary (NO in Act 14), the CPU 51 instructs paper discharge processing (Act 15). The CPU 51 determines that the reversal is unnecessary, for example, during simplex printing setting or after image formation on both the front and rear surfaces ends during duplex printing setting. As the paper discharge processing, the sheet P is guided to a conveying path leading to the paper discharge tray 12 by switching and discharged to the paper discharge tray 12 by the conveying roller pair 28 and the paper discharge roller pair 29.

On the other hand, if the CPU 51 determines that the reversal of the sheet P is necessary (YES in Act 14), the CPU 51 instructs the reversing device 18 to perform reversal processing (Act 16). As the reversal processing, processing for guiding, with a not-shown switching mechanism, the sheet P to the conveying path A1 leading to the reversing device 18 and reversing the front and rear surfaces of the sheet P with the reversing device 18 is performed.

After the reversal processing, the CPU 51 returns to Act 2. The CPU 51 performs the processing in Acts 3 to 12 again. Since the rear surface of the sheet P is faced to the outer side after the reversal processing, the CPU 51 determines “NO” in Act 4.

The CPU 51 performs second pressing processing (Act 8). In Act 8, since the surface of the sheet P already absorbs moisture through the image formation, charges easily escape because of the moisture. However, as explained above, since the potential difference is adjusted to be large in the second pressing processing after the reversal processing, it is possible to prevent an attraction failure. After the image forming processing on the rear surface ends, since the reversal is unnecessary, the CPU 51 determines that the reversal is unnecessary (NO in Act 14) and performs the paper discharge processing (Act 15).

With the inkjet recording apparatus 1 and the inkjet recording method according to this embodiment, when the sheet P, to the front surface of which the inks are supplied by the image formation, is subjected to the reversal processing and retained on the drum 13 again, attraction force is increased. Therefore, it is possible to suppress a decrease in the attraction force due to moisture of the inks supplied to the front surface.

In this embodiment, nip time can be extended to increase electrostatic force by adjusting the position of the charging roller 33. Therefore, it is possible to adjust attraction force without increasing electric power supplied to the charging roller 33. Therefore, compared with adjusting the attraction force by increasing the electric power supplied to the charging roller 33, it is possible to prevent power consumption from increasing and it is unnecessary to improve performance of a power supply. Therefore, it is possible to perform the adjustment of the attraction force with a simple configuration.

### Second Embodiment

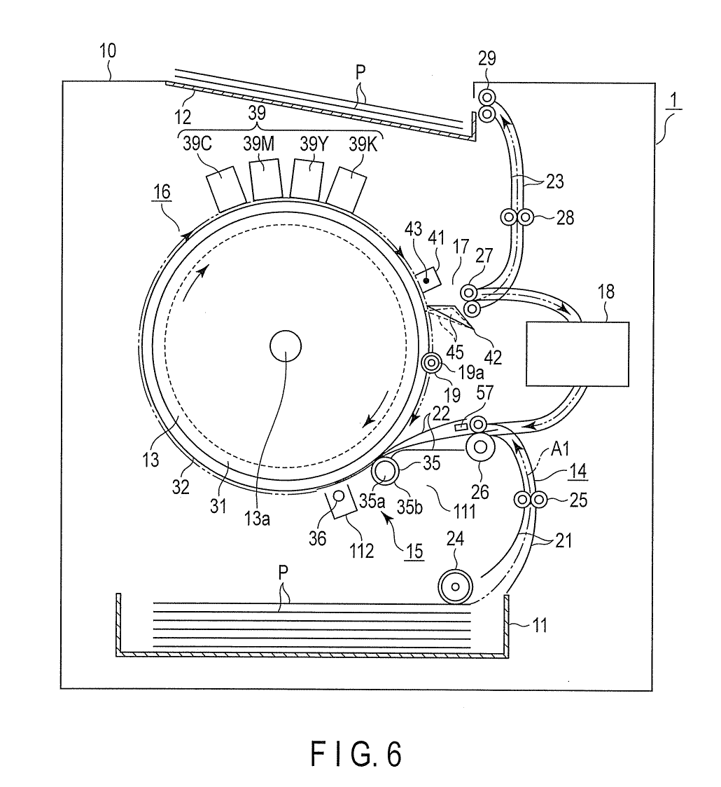

An inkjet recording apparatus 100 according to a second embodiment is explained below with reference to FIGS. 6 to 9. This embodiment is the same as the first embodiment except that a charging device is a non-contact type and a gap value is adjusted instead of adjusting a nip length. Therefore, common explanation is omitted.

The inkjet recording apparatus 100 includes, as the retaining device 15, a pressing device 111 configured to press the sheet P against the drum 13 and a non-contact-type charging device 112 configured to attract the sheet P to the drum 13 with electrostatic force by charging on the downstream side of the pressing device 111 with respect to the position where the guide member 22 and the drum 13 are in close contact with each other.

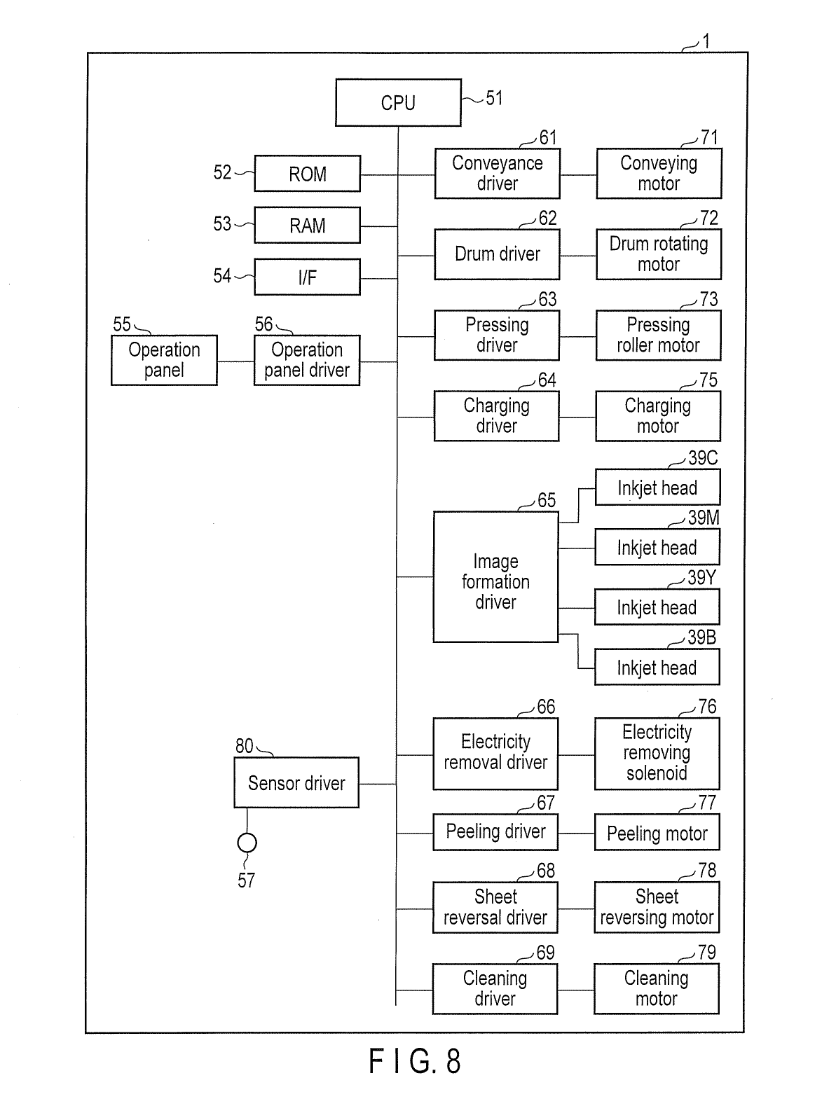

The pressing device 111 includes a pressing roller 35 (a pressing member) arranged to be opposed to the surface in the lower part of the drum 13 and a pressing motor 73 shown in FIG. 8 configured to drive the pressing roller 35.

The pressing roller 35 includes a shaft section 35a and a surface layer section 35b made of an insulating material and prevents charges of the charged sheet P from leaking through the pressing roller 35.

A load applied between the pressing roller 35 and the drum 13 is set to a proper value with which the sheet P is not deformed and image quality is not deteriorated. When the sheet P passes the nip between the drum 13 and the pressing roller 35, the sheet P is pressed against the drum 13 by the pressing roller 35, whereby the sheet P adheres to the surface of the drum 13 while creases of the sheet P are smoothed.

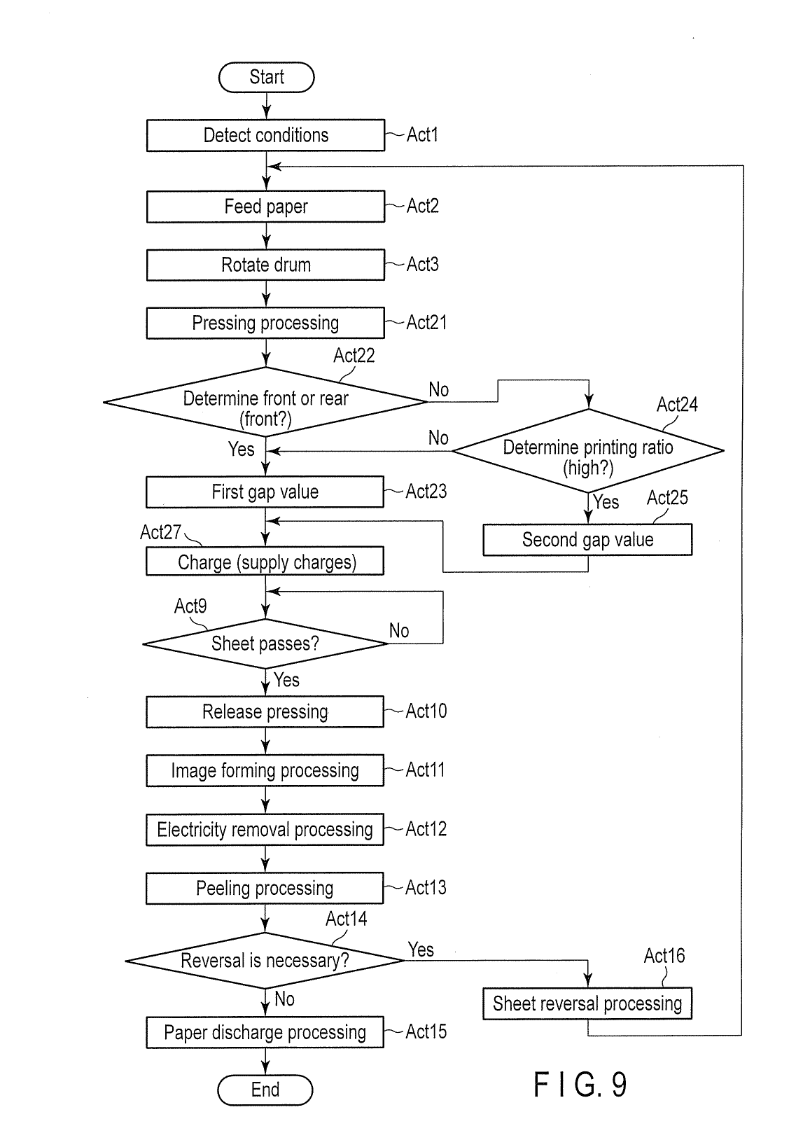

The charging device 112 includes a charging wire 36 (a charging member) arranged adjacent to and on the downstream side of the pressing roller 35 with respect to a position where the sheet P is conveyed from the resist roller pair 26 and comes into contact with the drum 13 and the charging motor 75 shown in FIG. 9 configured to move the charging device 112.

If charges are supplied to the charging wire 36, a potential difference between the charging wire 36 and the grounded cylindrical frame 31 occurs and electrostatic force in a direction in which the sheet P is attracted to the drum 13 is generated (the sheet P is charged).

The charging wire 36 is a chargeable wire of metal extending in parallel to the rotating shaft 13a. If electric power is supplied to the charging wire 36 in a state in which the charging wire 36 is in close contact with the drum 13, a potential difference between the charging wire 36 and the grounded cylindrical frame 31 occurs and electrostatic force in the direction in which the sheet P is attracted to the drum 13 is generated (the sheet P is charged). The sheet P is attracted to the surface of the drum 13 by the electrostatic force.

A state of supply of charges to the charging wire 36 can be switched. The charging wire 36 can move in a direction in which the position of the charging wire 36 approaches and separates from the surface of the drum 13. A gap value between the charging wire 36 and the drum 13 can be set in plural stages.

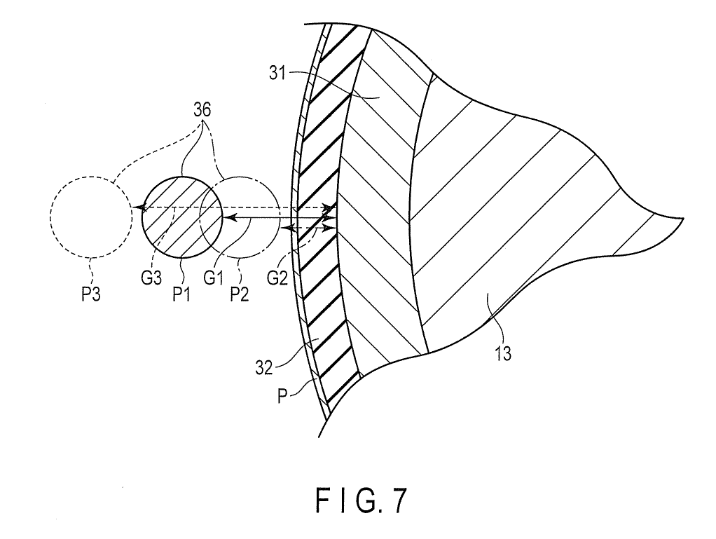

As shown in FIG. 7, the position of the charging wire 36 can be switched among a first position P1 where the charging wire 36 is arranged on the drum 13 via a first gap value G1, a second position P2 where the charging wire 36 is arranged on the drum 13 via a second gap value G2 smaller than the first gap value G1, and a third position P3 where the charging wire 36 is arranged on the drum 13 via a third gap value G3 larger than the first gap value G1 and retracts from the drum 13.

The potential difference between the charging wire 36 and the grounded cylindrical frame 31 changes according to a gap value between the charging wire 36 and the grounded cylindrical frame 31. Therefore, a potential difference at the second gap value G2 is larger than a potential difference at the first gap value G1. In this embodiment, the gap value is adjusted according to the movement of the charging wire 36 to adjust electrostatic force.

A block diagram of the inkjet recording apparatus 100 is shown in FIG. 8. Explanation of components same as those of the inkjet recording apparatus 1 according to the first embodiment is omitted or simplified. The inkjet recording apparatus 100 includes the CPU (central processing unit) 51, which is a controller, the ROM (read only memory) 52, the RAM (random access memory) 53, and the interface (I/F) 54. In the second embodiment, the inkjet recording apparatus 100 does not include the charging control driving circuit (driver) explained in the first embodiment. Instead, the inkjet recording apparatus 100 includes a pressing control driving circuit (driver) 63 configured to control the pressing motor 73 configured to bring the pressing roller 35 into contact with and separating the pressing roller 35 from the retaining drum 13 and a charging control driving circuit (driver) 64 connected to the pressing roller 35 and configured to supply charges to the pressing roller 35.

Actions of the inkjet recording apparatus 100 according to this embodiment are explained below with reference to a flowchart of FIG. 9. In an inkjet recording method according to this embodiment, processing in Act 22 to Act 27 is performed instead of Act 3 to Act 8 of the inkjet recording method according to the first embodiment. Since the other processing acts (Acts, 1, 2, 3, and 9 to 16) are the same as those in the first embodiment, explanation of the processing acts is omitted.

After the end of Act 2, the CPU 51 instructs the pressing motor control driving circuit (driver) 63 to cause the pressing roller 35 to press the drum 13 with predetermined pressing force (Act 21). The sheet P fed by the resist roller pair 26 is pressed against the drum 13 by the pressing roller 35 and winds around and adheres to the drum 13 while unevenness such as creases is smoothed.

The CPU 51 determines, on the basis of the condition of necessity of duplex printing detected in Act 1, whether present image formation is performed on the front surface (a first surface) (Act 22). If the CPU 51 determines that the present image formation is performed on the front surface (YES in Act 22), the CPU 51 instructs the charging control driving circuit (driver) 64 to arrange the charging wire 36 via the first gap value G1 (Act 23). The charging motor 75 is driven on the basis of the instruction. For example, in the case of a state in which the front surface of the sheet P before reversal is faced outward, the charging motor 75 is controlled to set the gap value to the first gap value G1.

On the other hand, if the CPU 51 determines that the present image formation is not performed on the front surface, i.e., determines that the present image formation is performed on the rear surface (a second surface) (NO in Act 22), the CPU 51 determines whether a printing ratio is higher than a threshold set in advance (Act 24). If the CPU 51 determines that the printing ratio is higher than the threshold set in advance (YES in Act 24), the CPU 51 instructs the pressing control driving circuit (driver) 63 to set the gap value to the second gap value G2 to be smaller than a reference value set to a value smaller than the first gap value G1 (Act 25).

On the other hand, if the CPU 51 determines that the printing ratio is lower than or equal to the threshold (NO in Act 24), the CPU 51 proceeds to Act 23.

The CPU 51 instructs the charging control driving circuit 64 to supply charges to the charging wire 36 and generate electrostatic force between the charging wire 36 and the drum 13 to attract the sheet P (Act 27). At this point, irrespective of the gap value, an amount of charges supplied to the charging wire 36 is the same. Timing of charging is set such that, for example, the charging wire 36 is charged immediately before the sheet P reaches the charging wire 36 according to the rotation of the drum 13. In this way, the gap setting is performed immediately before a charging action (voltage application).

The sheet P is attracted to and retained on the drum 13 by the electrostatic force generated by the potential difference between the charging wire 36 and the drum 13 and is directly conveyed to the inkjet head unit 39 according to the rotation of the drum 13.

After the sheet P is peeled, the surface of the drum 13 is cleaned by the cleaning member 19a. The drum 13 rotates in a state in which the drum 13 is in contact with the cleaning member 19a, whereby the cleaning member 19a cleans the surface of the drum 13.

With the inkjet recording apparatus 100 according to this embodiment, when the sheet P, to the surface of which the inks are supplied by the image formation, is subjected to the reversal processing and retained on the drum 13 again, the potential difference is increased to increase electrostatic attraction force by reducing the gap value. Therefore, it is possible to prevent the influence of a decrease in attraction force due to moisture of the inks supplied to the surface of the sheet P.

In this embodiment, the gap value can be reduced to increase electrostatic force by adjusting the position of the charging wire 36. Therefore, it is possible to adjust attraction force without increasing electric power supplied to the charging wire 36. Therefore, compared with the case of adjusting the attraction force by increasing the electric power supplied to the charging wire 36, it is possible to prevent power consumption from increasing and it is unnecessary to improve performance of a power supply. Therefore, it is possible to perform the adjustment of the attraction force with a simple configuration.

The present invention is not limited to the embodiments and can be modified as appropriate. In the embodiments, as an example of the adjusting processing for the second pressing force, the processing for determining the second pressing force according to a printing ratio is explained. However, the present invention is not limited to this. This adjusting operation may be omitted or the second pressing force may be adjusted on the basis of other conditions.

In the examples explained in the embodiments, the nip length and the gap values are changed according to the adjustment of the position of the charging wire 36. However, the present invention is not limited to this.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet recording apparatus comprising:
a retaining roller configured to retain a recording medium on a surface thereof and rotate;
a retaining device including a charging member arranged to be opposed to an outer circumferential surface of the retaining roller and configured to attract the recording medium to the surface of the retaining roller with electrostatic force and retain the recording medium on the surface of the retaining roller;
an inkjet head provided to be opposed to the outer circumferential surface of the retaining roller and configured to eject ink to the recording medium retained on the surface of the retaining roller to form an image on the recording medium;
a reversing device configured to reverse front and rear surfaces of the recording medium; and
a controller configured to control a position in an approaching and separating direction of the charging member with respect to the retaining roller to set a potential difference between the charging member and the retaining roller to a first potential difference if the recording medium is electrostatically attracted with a first surface of the recording medium faced to an outer side and to set the potential difference between the charging member and the retaining roller to a second potential difference larger than the first potential difference if the recording medium is reversed by the reversing device after image formation on the first surface of the recording medium and then electrostatically attracted with a second surface of the recording medium faced to the outer side.

2. The apparatus according to claim 1, wherein the controller increases the second potential difference if a printing ratio in the image formation on the first surface of the recording medium is higher than a threshold.

3. The apparatus according to claim 1, wherein an applied voltage or an amount of charges supplied to the charging member is the same irrespective of whether the recording medium is electrostatically attracted with the first surface of the recording medium faced to the outer side or the recording medium is electrostatically attracted with the second surface faced to the outer side after being reversed.

4. The apparatus according to claim 1, wherein the retaining device includes a contact-type charging device configured to press the charging member in a charged state against the retaining roller and attract the recording medium to the retaining roller with electrostatic force.

5. The apparatus according to claim 1, wherein the controller performs control to press, with the charging member, the recording medium against the surface of the retaining roller at a first nip length if the recording medium is electrostatically attracted with the first surface of the recording medium faced to the outer side and press, with the charging member, the recording medium against the surface of the retaining roller at a second nip length longer than the first nip length if the recording medium is reversed by the reversing device after the image formation on the first surface of the recording medium and then electrostatically attracted with the second surface of the recording medium faced to the outer side.

6. The apparatus according to claim 5, wherein
the surface of the retaining roller or the charging member is configured to be elastically deformable by pressing and a nip length between the surface of the retaining roller and the surface of the charging member is variable according to a load of the pressing, and
the controller controls a nip length between the charging member and the retaining roller by adjusting the load of the pressing.

7. The apparatus according to claim 6, wherein the controller controls the load of the pressing of the retaining roller and the charging member by adjusting a position of the charging member.

8. The apparatus according to claim 1, wherein the retaining device includes:
a pressing device configured to press the recording medium against and closely attach the recording medium to the retaining roller; and
a charging device of a non-contact type configured to bring the charging member in a charged state close to the retaining roller and attract the recording medium to the retaining roller with static electricity.

9. The apparatus according to claim 8, wherein the controller performs control to set a gap between the charging member and the retaining roller to a first gap value and arrange the charging member if the first surface of the recording medium is subjected to image formation and set the gap between the charging member and the retaining roller to a second gap value smaller than the first gap value and arrange the charging member if the recording medium is reversed by the reversing device after the image formation on the first surface of the recording medium and then the second surface of the recording medium is subjected to image formation.

10. The apparatus according to claim 1, wherein
the charging member and the retaining roller respectively include conductive sections and generate electrostatic force according to a potential difference between the conductive sections, and
the controller adjusts a gap between the charging member and the retaining roller and controls the potential difference.

11. An inkjet recording method comprising:
electrostatically attracting a recording medium to and retaining the recording medium on a surface of a rotating retaining roller with a first surface of the recording medium faced to an outer side on the surface of the retaining roller and with a potential difference between a retaining device and the retaining roller set as a first potential difference;
ejecting ink to the first surface of the recording medium retained on the retaining roller to form an image;
reversing front and rear of the recording medium after the image formation;
moving a charging member to the retaining roller side to set the potential difference to a second potential larger than the first potential;
electrostatically attracting the recording medium to and retaining the recording medium on the surface of the retaining roller with the a second surface of the recording medium faced to the outer side by the charging member on the surface of the retaining roller; and
ejecting ink to the second surface of the recording medium retained on the retaining roller to form an image.

12. The method according to claim 11, wherein the second potential difference is increased if a printing ratio in the image formation on the first surface of the recording medium is higher than a threshold.

13. The method according to claim 11, wherein charges supplied to the charging member are the same irrespective of whether the recording medium is electrostatically attracted with the first surface of the recording medium faced to the outer side or the recording medium is electrostatically attracted with the second surface faced to the outer side after being reversed.

14. The method according to claim 11, wherein the potential difference is controlled by pressing the charging member against the retaining roller in a charged state in electrostatically attracting and retaining the recording medium and a nip length between the charging member and the retaining roller is adjusted.

15. The method according to claim 14, wherein
a nip length between the surface of the retaining roller and a surface of the charging member is variable according to pressing force, and
the nip length between the charging member and the retaining member is controlled by adjusting a load of the pressing.

16. The method according to claim 11, wherein
the charging member is arranged to be opposed to the surface of the retaining roller and movable in a direction in which the charging member approaches and separates from the retaining roller, and
a nip length between the charging member and the retaining roller is controlled by adjusting a position of the charging member.

17. The method according to claim 11, wherein the charging member in a charged state is brought close to the retaining roller to attract the recording medium to the retaining roller and the potential difference is controlled by adjusting a gap value between the charging member and the retaining roller.

18. An inkjet recording apparatus comprising:
a retaining roller configured to retain a recording medium on the surface thereof and rotate;
a charging member arranged to be opposed to a surface of the retaining roller and configured to attract the recording medium to the surface of the retaining roller with electrostatic force and retain the recording medium on the surface of the retaining roller;
an inkjet head provided to be opposed to an outer circumferential surface of the retaining roller and configured to eject ink to the recording medium retained on the surface of the retaining roller to form an image on the recording medium;
a reversing device configured to reverse the front and rear surfaces of the recording medium; and
a controller configured to control a position in an approaching and separating direction of the charging member with respect to the retaining roller if the recording medium is reversed by the reversing device after image formation on a first surface of the recording medium and then electrostatically attracted with a second surface of the recording medium faced to an outer side.

19. The apparatus according to claim 18, wherein an applied voltage or an amount of charges supplied to the charging member is the same irrespective of whether the recording medium is electrostatically attracted with the first surface of the recording medium faced to the outer side or the recording medium is electrostatically attracted with the second surface faced to the outer side after being reversed.
